(19) United States
(12) Patent Application Publication
(10) Pub. No.: US 2022/0305301 A1
(43) Pub. Date: Sep. 29, 2022

(54) WEARABLE SYSTEM FOR CLEANING AIR

(71) Applicant: KOREA UNIVERSITY OF TECHNOLOGY AND EDUCATION INDUSTRY-UNIVERSITY COOPERATION, Cheonan-si, Chungcheongnam-do (KR)

(72) Inventor: Jeong Shick YOON, Asan-si (KR)

(21) Appl. No.: 17/290,190

(22) PCT Filed: Apr. 1, 2021
(86) PCT No.: PCT/KR2021/004093

§ 371 Date: Apr. 29, 2021

(30) Foreign Application Priority Data
Apr. 27, 2020 (KR) 10-2020-0050599

(51) Int. Cl. A62B 18/00; A62B 9/04; A62B 18/02

(52) U.S. Cl. CPC A62B 18/003; A62B 9/04; A62B 18/025; A62B 18/006

(57) ABSTRACT

A wearable system for cleaning air according to the present disclosure may include a mask device for wearing on a face of a user to inhale clean air, and an air cleaning means for generating clean air to be supplied to the mask device. The mask device may include a frame formed in a shape of surrounding lips and a nose of the user. One or more of nozzle portion for spraying clean air onto the face of the user may be formed at the frame. The nozzle portion may be connected to the air cleaning means and an air tube. The air cleaning means may be an air cleaner formed in a shape of a neck band to be worn around a neck of the user, or formed in a shape of being capable of wearing around a belt of the user.

### TECHNICAL FIELD

The present disclosure relates to a wearable system for cleaning air, and particularly relates to the wearable system for cleaning air which may transfer clean air generated by filtering fine dust or pathogens, etc. onto a face of a user upon doing actively outdoor activities such as riding, thereby assisting pleasant outdoor activities.

### BACKGROUND ART

Fine dust is floating matters having various complex compounds in an atmosphere, refers to particulate matters of which a diameter is 10 μm or less, and is particularly atmosphere pollution matters much generated from exhaust gases of manufacturing plants, or vehicles, etc when a fossil fuel such as coal, and petroleum is mainly burned.

It is known that the fine dust mainly includes carbon, organic hydrocarbon, a nitrate, a sulphate, harmful metal elements which are combustion particles, relates to occurrence of a respiratory disease and a cardiovascular disease, and makes a death rate increase.

Devices for removing fine dust as the above have been continuously developed, wherein most of devices for removing fine dust are mainly used in an indoor space. Accordingly, there is a problem that the devices cannot be used upon doing outdoor activities.

Therefore, a mask for blocking fine dust is needed for outdoor activities.

In the case of the mask for blocking fine dust for outdoor activities, a function of a fabric itself is improved in order that fine dust does not pass through the fabric for the mask.

Consequently, the mask for blocking fine dust itself may be considered as a kind of filter.

However, in the case of the mask for blocking fine dust, edges should be adhered to a face of a user to sufficiently obtain its effects. It is hardly difficult to maintain a state that edges of the mask for blocking fine dust are continuously adhered to the face of the user in outdoor activities.

For example, the case such that facial muscles move while the user talks with another person, or fine dust is introduced into a gap of a lateral portion due to carelessness of the user, etc. frequently occurs. Accordingly, there may be the case that fine dust cannot be blocked, and thus its function is lost.

Also, when a mask having a high fine dust blocking rate is used, there is a problem that air permeability is low to make breathing difficult. When wearing the mask in summer, the user significantly feels uncomfortable due to heat.

Recently, air cleaning masks which may supply clean air inside the mask in order that users smoothly breathe while wearing masks have been continuously developed.

Each of reference numerals described in FIGS. 1 to 4 to be described hereinafter represents only relevant components of each drawing.

FIG. 1 is a drawing presenting an air cleaning mask device disclosed in Korean registration patent publication No. 10-2035977.

The air cleaning mask device of D1 includes a frame 10 of an arc shape having a predetermined curvature, a battery 11 fixed to the frame 10, an air blower 12 which is installed in one side of the battery 11, in which a blowing fan rotating by power supplied from the battery 11 is embedded and installed, and which transfers wind, filters 13 and 14 which are installed at one side of the air blower 12 and filter dust, a blowing hose 15 in which air passing through the filters 13 and 14 and coming out therefrom flows, and a mask 20 including a hose fixture 21 for fixing the blowing hose 15.

FIG. 2 is a drawing presenting an air cleaning mask disclosed in Korean registration patent publication No. 10-1812681.

The air cleaning mask of FIG. 2 includes a body 110 which is settled in at least partial area of a face including a nose and lips of a user to form an inner space; a filter portion 120 which includes a filter 125, filters external air, and introduces the same into the inner space of the body 110; a valve portion which discharges or inhales air depending on inspiration or expiration of a user; and an environmental information detection portion 140 for detecting environmental information including air quality, wherein the filter portion 120 is configured to be detachably coupled to the body 110.

FIG. 3 is a drawing presenting a neck band type-air blower disclosed in Korean registration patent publication No. 10-1701828.

The neck band type-air blower of FIG. 3 inhales external air, filters the same, and then sprays purified air onto a face of a user or directly supplies the same through the mask, thereby effectively blocking fine dust. Also, apparatus is configured to be minimized to be portable, includes a body module 100 and an air module 200, and is formed in an oval ring shape in which an opening portion a is formed in one lateral direction on the whole.

FIG. 4 is a drawing presenting a wearable air cleaning mask disclosed in Korean registration patent publication No. 10-1797071.

The wearable air cleaning mask of FIG. 4 includes a mask portion which is worn around a face while surrounding lips and a nose in order that the lips and the nose of a user are separated from an outside, filters external air to supply the same to an inside, and includes a mask body 160 and a hair band 150; and a power supply portion 200 which is electrically connected to the mask portion and supplies power to the mask portion. The mask portion includes an inhalation portion 120 for inhaling external air and a filter portion 110 for filtering air inhaled by the inhalation portion 120. The power supply portion 200 supplies power to the inhalation portion 120.

Masks disclosed in FIGS. 1, 2, and 4 as the above are formed such that the mask portion worn around the face of the user is to be integrated with other components, so that washing is not easy. In order to replace the mask portion, all of other components should be changed. Therefore, there is a problem that a lot of costs are consumed.

Also, the neck band type-air blower of FIG. 3 as previously described is positioned to be somewhat separated from a respiratory organ of the user. Accordingly, there is a problem that it is difficult that users actually feel inflow of clean air directly.

### DOCUMENTS OF THE RELATED ART

### Patent Documents

(Patent document 1) KR 10-2035977 B1 (published on Oct. 23, 2019)

(Patent document 2) KR 10-1812681 B1 (published on Dec. 27, 2017)

(Patent document 3) KR 10-1701828 B1 (published on Feb. 2, 2017)

(Patent document 4) KR 10-1797071 B1 (published on Dec. 12, 2017)

### DISCLOSURE

### Technical Problem

The present disclosure is for providing a wearable system for cleaning air which may transfer clean air generated by filtering fine dust, or pathogens, etc. onto a face of a user upon doing actively outdoor activities such as riding, thereby assisting pleasant outdoor activities.

### Technical Solution

According to a first view point of the present disclosure for achieving the above, a mask device for inhaling clean air may be the mask device which is worn around a face of a user to inhale clean air. The above may include a frame formed in a shape of surrounding lips and a nose of the user, one or more of nozzle portion may be formed at the frame to spray clean air onto the face of the user, and the nozzle portion may be connected to a predetermined air cleaner and an air tube.

As other example, a mask device for inhaling clean air of the present disclosure may be the mask device which is worn around a face of a user to inhale clean air. The above may include a frame formed in a shape of surrounding lips and a nose of the user, one or more of nozzle portion may be formed at the frame to spray clean air onto the face of the user, and the nozzle portion may be connected to a predetermined air cleaner and an air tube. The frame may include an outer frame for forming a boundary, and a supporting frame which is positioned at a center of the outer frame and of which an upper end and a lower end are connected to an upper side and a lower side of the outer frame respectively. A pair of holes for coupling may be formed at both sides in a criterion of the supporting frame between the outer frame and the supporting frame. A filter portion may be coupled to the holes for coupling.

As other example, a mask device for inhaling clean air of the present disclosure is the mask device which is worn around a face of a user to inhale clean air. The above may include a frame formed in a shape of surrounding lips and a nose of the user, one or more of nozzle portion may be formed at the frame to spray clean air onto the face of the user, and the nozzle portion may be connected to a predetermined air cleaner and an air tube. At both sides of the frame, earring portions which are formed in a strap shape and are worn around ears of the user may be formed, or a hair band portion which is formed in a band shape and is worn on hair of the user may be formed.

As other example, a mask device for inhaling clean air of the present disclosure is the mask device which is worn around a face of a user to inhale clean air. The above may include a frame formed in a shape of surrounding lips and a nose of the user. One or more of nozzle portion may be formed at the frame to spray clean air onto the face of the user. The nozzle portion may be connected to a predetermined air cleaner and an air tube. The frame may include an outer frame for forming a boundary, and a supporting frame which is positioned at a center of the outer frame and of which an upper end and a lower end are connected to an upper side and a lower side of the outer frame respectively. A silicon layer may be formed on a surface to be in contact with the face of the user in the outer frame.

As other example, a mask device for inhaling clean air of the present disclosure is the mask device which is worn around a face of a user to inhale clean air. The above may include a frame formed in a shape of surrounding lips and a nose of the user. One or more of nozzle portion may be formed at the frame to spray clean air onto the face of the user. The nozzle portion may be connected to a predetermined air cleaner and an air tube. The frame may include an outer frame for forming a boundary, and a supporting frame which is positioned at a center of the outer frame, and of which an upper end and a lower end are connected to an upper side and a lower side of the outer frame respectively. The outer frame includes a first frame which is arranged at a left side in a criterion of the supporting frame; and a second frame which is arranged at a right side in a criterion of the supporting frame and is coupled to the first frame. The first frame, the second frame, and the supporting frame are coupled in a hinge way, so that the first frame and the second frame are configured to be folded or unfolded at a certain angle in a criterion of the supporting fame.

Meanwhile, according to a second view point of the present disclosure, a wearable system for cleaning air may include a mask device for wearing on a face of a user to inhale clean air, and an air cleaning means for generating clean air to be supplied to the mask device. The mask device may include a frame formed in a shape of surrounding lips and a nose of the user. One or more of nozzle portion for spraying clean air onto the face of the user is formed at the frame. The nozzle portion may be connected to the air cleaning means and an air tube. The air cleaning means may be an air cleaner formed in a shape of a neck band to be worn around a neck of the user, or formed in a shape of being capable of wearing around a belt of the user.

As other example, a wearable system for cleaning air of the present disclosure may include a mask device for wearing on a face of a user to inhale clean air, and an air cleaning means for generating clean air to be supplied to the mask device. The mask device may include a frame formed in a shape of surrounding lips and a nose of the user. One or more of nozzle portion for spraying clean air onto the face of the user may be formed at the frame. The nozzle portion may be connected to the air cleaning means and an air tube. The frame may include an outer frame for forming a boundary, and a supporting frame which is positioned at a center of the outer frame, and of which an upper end and a lower end are connected to an upper side and a lower side of the outer frame respectively. A pair of holes for coupling may be formed at both sides in a criterion of the supporting frame between the outer frame and the supporting frame. A filter portion may be coupled to the holes for coupling. The air cleaning means may be an air cleaner formed in a shape of a neck band to be worn around a neck of the user, or formed in a shape of being capable of wearing around a belt of the user.

As other example, a wearable system for cleaning air of the present disclosure may include a mask device for wearing on a face of a user to inhale clean air, and an air cleaning means for generating clean air to be supplied to the mask device. The mask device may include a frame formed in a shape of surrounding lips and a nose of the user. One or more of nozzle portion for spraying clean air onto the face of the user may be formed at the frame. The nozzle portion may be connected to the air cleaning means and an air tube. At both sides of the frame, earring portions which are formed in a strap shape and are worn around ears of the user may be formed, or a hair band portion which is formed in a band shape and is worn on hair of the user may be formed. The air cleaning means may be an air cleaner formed in a shape of a neck band to be worn around a neck of the user, or formed in a shape of being capable of wearing around a belt of the user.

As other example, a wearable system for cleaning air of the present disclosure may include a mask device for wearing on a face of a user to inhale clean air, and an air cleaning means for generating clean air to be supplied to the mask device. The mask device may include a frame formed in a shape of surrounding lips and a nose of the user. One or more of nozzle portion for spraying clean air onto the face of the user may be formed at the frame. The nozzle portion may be connected to the air cleaning means and an air tube. The frame may include an outer frame for forming a boundary, and a supporting frame which is positioned at a center of the outer frame, and of which an upper end and a lower end are connected to an upper side and a lower side of the outer frame respectively. A silicon layer may be formed on a surface to be in contact with the face of the user in the outer frame. The air cleaning means may be an air cleaner formed in a shape of a neck band to be worn around a neck of the user, or formed in a shape of being capable of wearing around a belt of the user.

As other example, a wearable system for cleaning air of the present disclosure may include a mask device for wearing on a face of a user to inhale clean air, and an air cleaning means for generating clean air to be supplied to the mask device. The mask device may include a frame formed in a shape of surrounding lips and a nose of the user. One or more of nozzle portion for spraying clean air onto the face of the user may be formed at the frame. The nozzle portion may be connected to the air cleaning means and an air tube. The frame may include an outer frame for forming a boundary, and a supporting frame which is positioned at a center of the outer frame, and of which an upper end and a lower end are connected to an upper side and a lower side of the outer frame respectively. The outer frame may include a first frame which is arranged at a left side in a criterion of the supporting frame; and a second frame which is arranged at a right side in a criterion of the supporting frame and is coupled to the first frame. The first frame, the second frame, and the supporting frame may be coupled in a hinge way, so that the first frame and the second frame are configured to be folded or unfolded at a certain angle in a criterion of the supporting fame. The air cleaning means may be an air cleaner formed in a shape of a neck band to be worn around a neck of the user, or formed in a shape of being capable of wearing around a belt of the user.

Specific matters of other examples are included in “DETAILED DESCRIPTION OF THE EMBODIMENTS” and “DRAWINGS” as enclosed.

Advantages and/or features of the present disclosure, and a method of achieving the same will be clarified by referring to various embodiments which are specifically described hereinafter together with enclosed drawings.

However, the following should be understood. The present disclosure is not limited by only configurations of each example to be disclosed hereinafter but may be also realized in various different forms. Each example disclosed in this specification is provided to complete the content of the present disclosure and to fully inform those skilled in the art of a category of the present disclosure. The present disclosure is merely defined by a category of each claim in the scope of claims.

### Advantageous Effects

According to the present disclosure, one or more of nozzle portion may be formed at the frame to spray clean air onto a face of a user. The nozzle portion may be connected to a predetermined air cleaner and an air tube. Accordingly, clean air generated from the air cleaner may be transferred onto a front face of the user, and thus it is possible to do pleasantly outdoor activities.

Also, according to the present disclosure, a filter portion may be coupled to holes for coupling formed at the frame, so that fine dust, or pathogens, etc. may be blocked from the outside when the user wears the mask device.

In addition, according to the present disclosure, earring portions or a hair band portion may be formed at both sides of the frame. Accordingly, stable wearing state may be maintained while the user wears the mask device and does outdoor activities.

Also, according to the present disclosure, the silicon layer may be formed on a surface to be in contact with the face in the frame. Accordingly, the mask device may be adhered to the face of the user, so that it may be blocked that fine dust, or pathogens, etc. are permeated from the outside.

In addition, according to the present disclosure, the frame may include the outer frame including the first and second frames, and the supporting frame. The first frame and the second frame are configured to be folded or unfolded at a certain angle in a criterion of the supporting fame. Accordingly, the frame may be adjusted to be used depending on users having different sizes and shapes of the faces.

Also, according to the present disclosure, the air cleaning means may be provided as the air cleaner formed in a shape of a neck band to be worn around a neck of the user or formed in a shape of being capable of being worn around a belt of the user. Accordingly, there may be convenience of being portable when the user does outdoor activities.

### DESCRIPTION OF DRAWINGS

FIG. 1 is a drawing of presenting an air cleaning mask device disclosed in Korean registration patent publication No. 10-2035977.

FIG. 2 is a drawing of presenting an air cleaning mask disclosed in Korean registration patent publication No. 10-1812681.

FIG. 3 is a drawing of presenting a neck band type-air blower disclosed in Korean registration patent publication No. 10-1701828.

FIG. 4 is a drawing of presenting a wearable air cleaning mask disclosed in Korean registration patent publication No. 10-1797071.

FIG. 5 is a drawing of presenting a mask device for inhaling clean air.

FIG. 6 is a drawing of presenting a state that a filter portion is coupled to the mask device for inhaling clean air of FIG. 5.

FIGS. 7A and 7B present modified examples of the mask device for inhaling clean air of FIG. 6, wherein FIG. 7A is a drawing in which earring portions are formed, and FIG. 7B is a drawing in which a hair band is formed.

FIG. 8 is a drawing of presenting a state that the mask device for inhaling clean air of FIG. 5 is worn, and then a general mask is worn.

FIG. 9 is a drawing of presenting a state that the mask device for inhaling clean air of FIG. 5 is folded at a certain angle by step.

FIG. 10 is a drawing of schematically presenting a wearable system for cleaning air according to the second view point of the present disclosure.

FIGS. 11A and 11B is a drawing of presenting examples of the air cleaning means of FIG. 10, wherein FIG. 11A is a neck band shape-air cleaner, and FIG. 11B is a belt wearing shape-air cleaner.

FIG. 12 is a drawing of presenting a state that the mask device for inhaling clean air and the neck band shape-air cleaner, according to the present disclosure are combined.

FIG. 13A is a drawing of presenting a state that the mask device for inhaling clean air and the neck band shape-air cleaner of FIG. 12 are worn.

FIG. 13B is a drawing of presenting a state of wearing a general mask on the mask device for inhaling clean air of FIG. 13A.

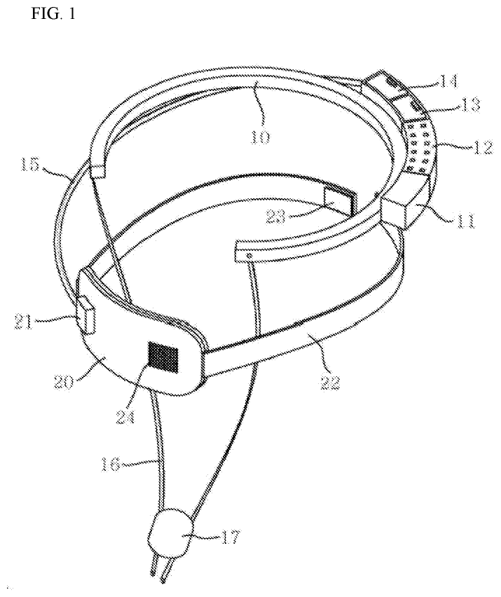

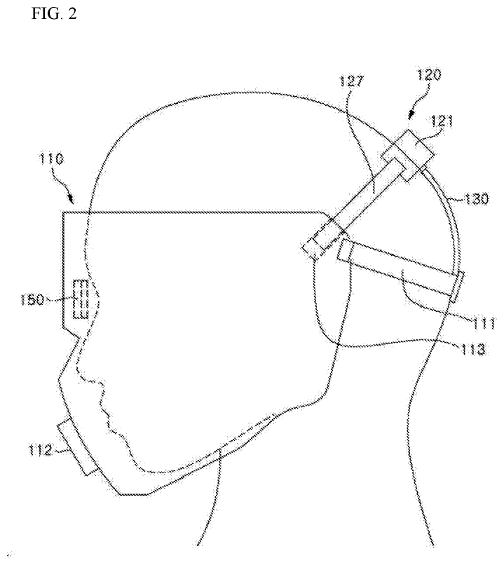

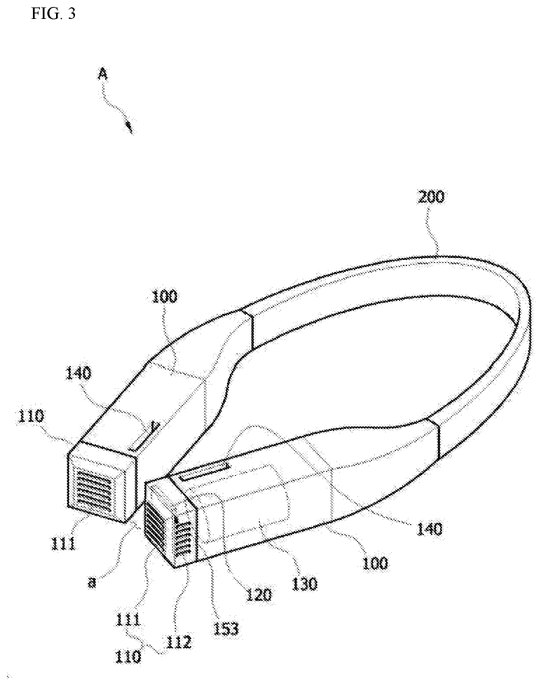

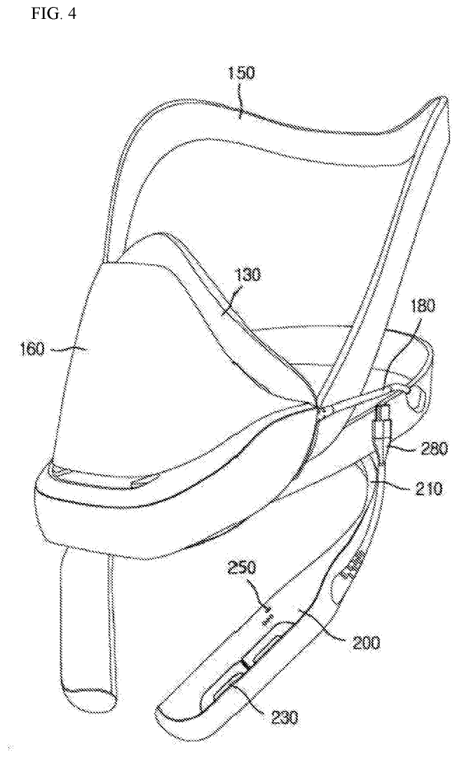

### BEST MODE

Hereinafter, referring to the enclosed drawings, preferable examples of the present disclosure will be specifically described as follows.

Before describing the preset disclosure specifically, the following should be understood. The terms or words used in this specification should not be construed to be unconditionally limited as a conventional or lexical meaning but an inventor of the present disclosure may properly define and use concepts of various terms to describe his/her invention in the best method. Furthermore, these terms or words should be construed as the meaning and concept corresponding to the technical spirit of the present disclosure.

That is, the following should be understood. The term used in this specification is merely used for describing a preferable example of the present disclosure, and is not used with intent of specifically limiting the content of the present disclosure. These terms are the terms defined under consideration of various possibilities of the present disclosure.

Also, the following should be understood. A singular expression used in this specification may include a plural expression as long as the expression is not definitely indicated as a different meaning in the context. Similarly, even if there is the plural expression, the expression may include the singular meaning.

Throughout a whole of this specification, when there is the description that any component “includes” another component, it may mean that any different component is not excluded but the any different component may be further included as long as there is no description particularly opposite to the above.

Furthermore, the following should be understood. When there is the description that any component “exists in an inside of another component, or is connected thereto to be installed therein”, this component may be directly coupled to another component, or be in contact with the same to be installed therein, and may be spaced apart from the same by a certain distance to be installed therein. With respect to the case of being spaced apart from the same by a certain distance to be installed therein, there may be a third component or means for fixing and connecting the relevant component to another component. The description of the third component or means may be omitted.

On the contrary, it should be understood that when there is the description that any component is “directly coupled”, or “directly connected” to another component, there is no third component or means.

Identically, other expressions for describing a relation of each component, that is, “˜between” and “directly˜between”, or “neighboring˜” and “directly neighboring”, etc. should be construed to have the above intent.

Also, if the terms such as “one surface”, “another surface”, “one side”, “another side”, “first”, and “second” are used in this specification, the following should be understood. The terms are used with respect to one component so as to distinguish this one component from another component, wherein the terms are not used in order that the meaning of the relevant component is limited by the terms as the above.

Also, if the terms related to positions such as “upper”, “lower”, “left”, and “right” are used in this specification, it should be understood that the terms represent relative positions in the relevant drawing with respect to the relevant component. As long as absolute positions with respect to these positions are not specified, the terms related to these positions should not be understood as referring to absolute positions.

Moreover, when the terms “portion”, “apparatus”, “module”, “device” etc. are used in specification of the present disclosure, the terms mean units that may process one or more of function or operation. The above may be realized by hardware or software, or combinations of the hardware and the software.

Also, in this specification, when a reference numeral is described with respect to each component of each drawing, an identical component has an identical reference numeral even if this component is presented in other drawings. That is, throughout the whole of specification, identical reference numerals denote identical components.

A size, a position, a combination relation, etc. of each component configuring the present disclosure in the attached drawings of the present disclosure may be described to be partially exaggerated, minimized, or omitted so as to sufficiently and clearly deliver the spirit of the present disclosure or for convenience of the description. Therefore, their proportion or scale may not be precise.

Also, in describing the present disclosure hereinafter, a configuration, for example, the detailed description of known technologies including conventional technologies may be omitted if it is deemed to make the gist of the present disclosure unnecessarily vague.

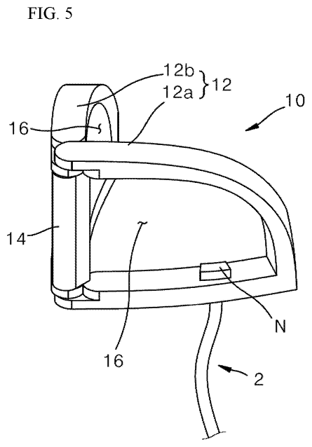

FIG. 5 is a drawing of presenting a mask device for inhaling clean air according to a first view point of the present disclosure.

The mask device for inhaling clean air according to the present disclosure is for wearing on a face of a user to inhale clean air, wherein a frame 10 formed in a shape of surrounding lips and a nose of the user may be included.

One or more of nozzle portion N for spraying clean air onto the face of the user may be formed at the frame 10, wherein the nozzle portion N may be preferably positioned at a lower side of the frame 10.

Also, the nozzle portion N may be connected to a portable air cleaner and an air tube 2.

That is, one end of the air tube 2 may be connected to the air cleaner. The other end of the air tube 2 may be connected to be communicated with the nozzle portion N of a part of the frame 10, in which the nozzle portion N is formed.

In addition, the mask device for inhaling clean air according to the present disclosure may employ a lower exhaust method to facilitate inhalation and exhaust of the user, and may be formed in a shape of being adhered to the face of the user to minimize occurrence of moisture in glasses, or goggles, etc.

This lower exhaust method is a well-known art, so that the description thereof is omitted.

As the above, in order to spray clean air onto the face of the user, one or more of nozzle portion N may be formed, and the nozzle portion N may be connected to a predetermined air cleaner and an air tube 2. Accordingly, clean air generated in the air cleaner may be transferred to the front face of the user, thereby allowing doing pleasant outdoor activities.

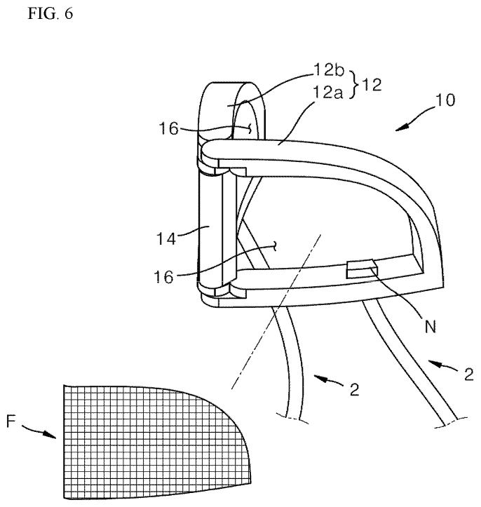

FIG. 6 is a drawing of presenting a state that a filter portion is coupled to the mask device for inhaling clean air of FIG. 5.

A mask device for inhaling clean air of the present disclosure is for wearing on a face of a user to inhale clean air, wherein a frame 10 formed in a shape of surrounding lips and a nose of the user may be included.

One or more of nozzle portion N for spraying clean air onto the face of the user may be formed at the frame 10, wherein the nozzle portion N may be preferably positioned at a lower side of the frame 10.

Also, the nozzle portion N may be connected to a portable air cleaner and an air tube 2.

That is, one end of the air tube 2 may be connected to the air cleaner. The other end of the air tube 2 may be connected to be communicated with the nozzle portion N of a part of the frame 10 in which the nozzle portion N is formed.

The mask device for inhaling clean air according to the present disclosure may employ a lower exhaust method to facilitate inhalation and exhaust of the user, and may be formed in a shape of being adhered to the face of the user to minimize occurrence of moisture in glasses or goggles, etc.

This lower exhaust method is a well-known art, so that the description thereof is omitted.

The frame as the above is configured to include an outer frame 12 for forming a boundary, and a supporting frame 14 which is positioned at a center of the outer frame 12 and of which an upper end and a lower end are connected to an upper side and a lower side of the outer frame 12 respectively.

Here, a pair of holes for coupling 16 may be formed at both sides in a criterion of the supporting frame 14 between the outer frame 12 and the supporting frame 14. A filter portion F may be detachably coupled to the holes for coupling 16.

As the above, a configuration that the filter portion F is detachably coupled to the filter portion F is a well known art, and thus may be variously realized. For example, coupling may be made by employing a magnet at an inner circumferential surface of holes for coupling 16 and an outer circumferential surface of the filter portion F.

The filter portion F may include a filter and a filter casing for accommodating the filter. The filter such as a HEPA filter for filtering fine dust in external air, an antibacterial filer for filtering pathogens, etc. may be employed.

Also, as the filter of the filter portion F, a filter having a function of occurrence of a negative ion may be used to enhance an effect of air cleaning, wherein a material having an effect of air cleaning such as phytoncide may be used to more enhance an antibacterial effect.

A circumferential shape of holes for coupling 16 and an outer shape of the filter portion F are formed to correspond to each other, wherein the filter portion F is detachably coupled to the holes for coupling 16. It may be prevented that fine dust, or pathogens, etc. are permeated from the outside into the face of the user, who wears the mask device.

Meanwhile, a silicon layer may be formed on a surface to be in contact with the face of the user in the outer frame 12.

As the above, the silicon layer may be formed on a surface to be in contact with the face in the outer frame 12. Accordingly, the mask device may be adhered to the face of the user, thereby preventing permeation of fine dust, or pathogens, etc. from the outside.

In addition, the outer frame 12 itself may be manufactured by silicon, wherein a silicon layer may be formed on an overall surface facing the face of the user in the outer frame 12.

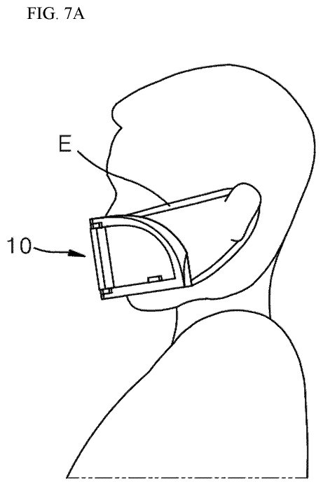

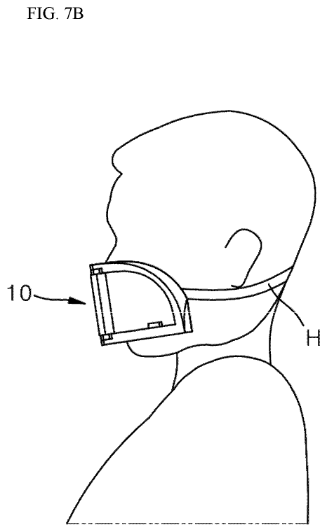

FIGS. 7A and 7B present modified examples of the mask device for inhaling clean air of FIG. 6, wherein FIG. 7A is a drawing in which earring portions are formed, and FIG. 7B is a drawing in which a hair band is formed.

A mask device for inhaling clean air of the present disclosure is for wearing on a face of a user to inhale clean air, wherein a frame 10 formed in a shape of surrounding lips and a nose of the user may be included.

One or more of nozzle portion N for spraying clean air onto the face of the user may be formed at the frame 10, wherein the nozzle portion N may be preferably positioned at a lower side of the frame 10.

Also, the nozzle portion N may be connected to a portable air cleaner and an air tube 2.

That is, one end of the air tube 2 may be connected to the air cleaner. The other end of the air tube 2 may be connected to be communicated with the nozzle portion N of a part of the frame 10 in which the nozzle portion N is formed.

The mask device for inhaling clean air according to the present disclosure may employ a lower exhaust method to facilitate inhalation and exhaust of the user, and is formed in a shape of being adhered to the face of the user to minimize occurrence of moisture in glasses or goggles, etc.

This lower exhaust method is a well-known art, so that the description thereof is omitted.

Here, at both sides of the frame 10, earring portions E which are formed in a strap shape and are worn around ears of the user may be formed, or a hair band portion H which is formed in a band shape and is worn on hair of the user may be formed.

As the above, the earring portions E or the hair band portion H may be formed at both sides of the frame 10. Accordingly, when the user wears the mask device and does outdoor activities, a stable wearing state may be maintained.

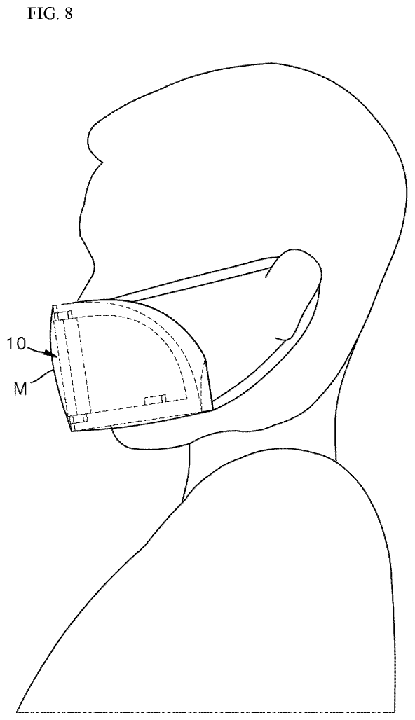

FIG. 8 is a drawing of presenting a state that the mask device for inhaling clean air of FIG. 5 is worn, and then a general mask is worn.

In a state of wearing the mask device for inhaling clean air (the mask device in which the earring portions E or the hair band portion H of FIG. 7 as previously described are not formed), the user may wear a general mask (or a mask for blocking fine dust) M thereon.

Here, when the general mask M is worn, a filer portion F may be coupled to the mask device for inhaling clean air as required. When the mask for blocking fine dust M is worn, the filter portion F may be coupled to the mask device so as to doubly filter, or the filter portion F may not be coupled.

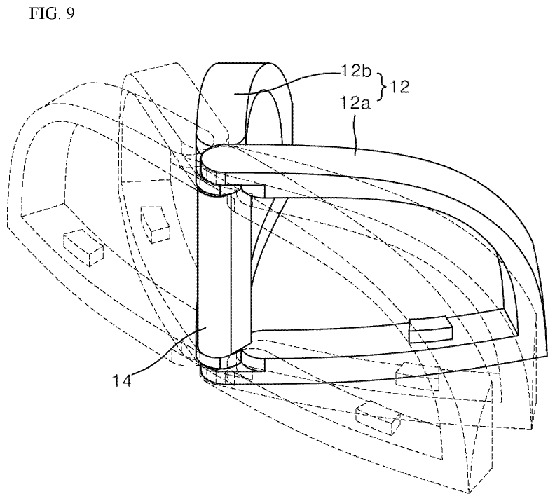

FIG. 9 is a drawing of presenting a state that the mask device for inhaling clean air of FIG. 5 is folded at a certain angle by step.

A mask device for inhaling clean air of the present disclosure is for wearing on a face of a user to inhale clean air, wherein a frame 10 formed in a shape of surrounding lips and a nose of the user may be included.

One or more of nozzle portion N for spraying clean air onto the face of the user may be formed at the frame 10, wherein the nozzle portion N may be preferably positioned at a lower side of the frame 10.

Also, the nozzle portion N may be connected to a portable air cleaner and an air tube 2.

That is, one end of the air tube 2 may be connected to the air cleaner. The other end of the air tube 2 may be connected to be communicated with the nozzle portion N of a part of the frame 10 in which the nozzle portion N is formed.

The mask device for inhaling clean air according to the present disclosure may employ a lower exhaust method to facilitate inhalation and exhaust of the user, and may be formed in a shape of being adhered to the face of the user to minimize occurrence of moisture in glasses, or goggles, etc.

This lower exhaust method is a well-known art, so that the description thereof is omitted.

Here, the frame 10 may include an outer frame 12 for forming a boundary, and a supporting frame 14 which is positioned at a center of the outer frame 12 and of which an upper end and a lower end are connected to an upper side and a lower side of the outer frame 12 respectively,

The outer frame as the above may include a first frame 12a which is arranged at a left side in a criterion of the supporting frame 14 (in a criterion of the user who wears the mask device); and a second frame 12b which is arranged at a right side in a criterion of the supporting frame 14 and is coupled to the first frame 12a.

The first frame 12a, the second frame 12b, and the supporting frame 14 may be coupled in a hinge way, so that the first frame 12a and the second frame 12b are configured to be folded or unfolded at a certain angle in a criterion of the supporting fame 14. A hinge device may be installed inside the supporting frame 14.

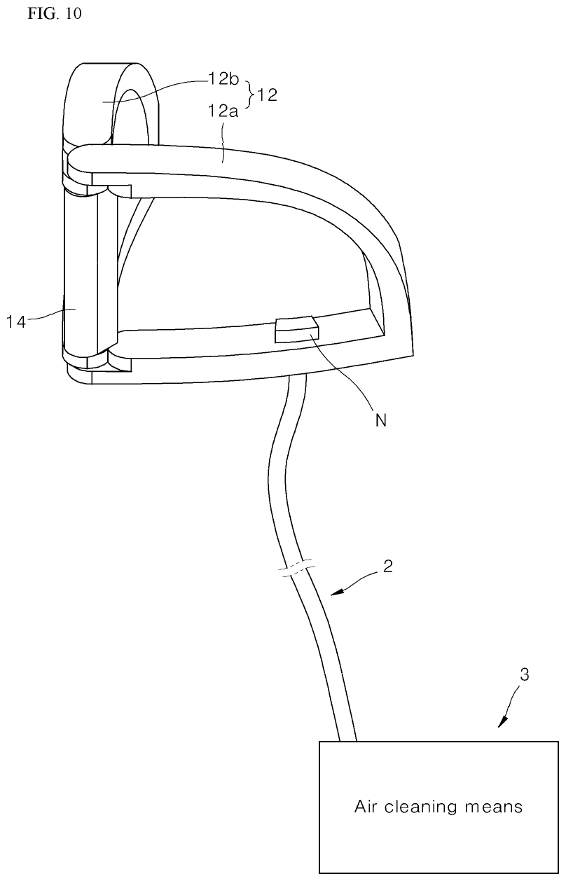

As the above, the frame 10 includes the outer frame 12 including the first and second frames 12a and 12b, and the supporting frame 14. The first frame 12a and the second frame 12b are configured to be folded or unfolded at a certain angle in a criterion of the supporting fame 14. Accordingly, the frame 10 may be adjusted to be used depending on users having different sizes and shapes of the faces. FIG. 10 is a drawing of schematically presenting a wearable system for cleaning air according to the second view of the present disclosure.

Meanwhile, according to a second view point of the present disclosure, a wearable system for cleaning air may include a mask device for wearing on a face of a user to inhale clean air, and an air cleaning means 3 for generating clean air to be supplied to the mask device.

The mask device may include a frame 10 formed in a shape of surrounding lips and a nose of the user, wherein one or more of nozzle portion N for spraying clean air onto the face of the user may be formed at the frame 10. The nozzle portion N may be connected to the air cleaning means 3 and an air tube 2.

The air cleaning means 3 may be a portable neck band shape-air cleaner, or a belt wearing shape-air cleaner as described hereinafter. This technology about a portable air cleaner is a well know art. Therefore, the description about the same is omitted.

As other example, a wearable system for cleaning air of the present disclosure may include a mask device for wearing on a face of a user to inhale clean air, and an air cleaning means 3 for generating clean air to be supplied to the mask device.

The mask device may include a frame 10 formed in a shape of surrounding lips and a nose of the user, wherein one or more of nozzle portion N for spraying clean air onto the face of the user may be formed at the frame 10. The nozzle portion N may be connected to the air cleaning means 3 and an air tube 2.

The frame 10 may include an outer frame 12 for forming a boundary, and a supporting frame 14 which is positioned at a center of the outer frame 12 and of which an upper end and a lower end are connected to an upper side and a lower side of the outer frame 12 respectively.

Here, a pair of holes for coupling 16 may be formed at both sides in a criterion of the supporting frame 14 between the outer frame 12 and the supporting frame 14. A filter portion F may be detachably coupled to the holes for coupling 16.

As the above, a configuration that the filter portion F is detachably coupled to the holes for coupling 16 is a well known art, and thus may be variously realized. For example, coupling may be made by employing a magnet at an inner circumferential surface of holes for coupling 16 and an outer circumferential surface of the filter portion F.

The filter portion F may include a filter and a filter casing for accommodating the filter. The filter such as a HEPA filter for filtering fine dust in external air, an antibacterial filer for filtering pathogens, etc. may be employed.

Also, as the filter of the filter portion F, a filter having a function of occurrence of a negative ion is used to enhance an effect of air cleaning, wherein a material having an effect of air cleaning such as phytoncide may be used to more enhance an antibacterial effect.

As other example, a wearable system for cleaning air of the present disclosure may include a mask device for wearing on a face of a user to inhale clean air, and an air cleaning means 3 for generating clean air to be supplied to the mask device.

The mask device may include a frame 10 formed in a shape of surrounding lips and a nose of the user, wherein one or more of nozzle portion N for spraying clean air onto the face of the user may be formed at the frame 10. The nozzle portion N may be connected to the air cleaning means 3 and an air tube 2.

Hear, at both sides of the frame 10, earring portions which are formed in a strap shape and are worn around ears of the user may be formed, or a hair band portion which is formed in a band shape and is worn on hair of the user may be formed.

As the above, the earring portions or the hair band portion may be formed at both sides of the frame 10. Accordingly, when the user wears the mask device and does outdoor activities, a stable wearing state may be maintained.

As other example, a wearable system for cleaning air of the present disclosure may include a mask device for wearing on a face of a user to inhale clean air, and an air cleaning means 3 for generating clean air to be supplied to the mask device.

The mask device may include a frame 10 formed in a shape of surrounding lips and a nose of the user, wherein one or more of nozzle portion N for spraying clean air onto the face of the user may be formed at the frame 10. The nozzle portion N may be connected to the air cleaning means 3 and an air tube 2.

Here, the frame 10 may include an outer frame 12 for forming a boundary, and a supporting frame 14 which is positioned at a center of the outer frame 12 and of which an upper end and a lower end are connected to an upper side and a lower side of the outer frame 12 respectively. A silicon layer may be formed on a surface to be in contact with the face of the user in the outer frame 12.

As the above, the silicon layer may be formed on a surface to be in contact with the face in the frame 10. Accordingly, the mask device may be adhered to the face of the user, so that it may be blocked that fine dust, or pathogens, etc. are permeated from the outside.

In addition, the outer frame 12 itself may be manufactured by silicon, wherein a silicon layer may be formed on an overall surface facing the face of the user in the outer frame 12.

As other example, a wearable system for cleaning air of the present disclosure may include a mask device for wearing on a face of a user to inhale clean air, and an air cleaning means 3 for generating clean air to be supplied to the mask device.

The mask device may include a frame 10 formed in a shape of surrounding lips and a nose of the user, wherein one or more of nozzle portion N for spraying clean air onto the face of the user may be formed at the frame 10. The nozzle portion N may be connected to the air cleaning means 3 and an air tube 2.

The frame 10 may include an outer frame 12 for forming a boundary, and a supporting frame 14 which is positioned at a center of the outer frame 12 and of which an upper end and a lower end are connected to an upper side and a lower side of the outer frame 12 respectively.

The outer frame 12 may include a first frame 12a which is arranged at a left side in a criterion of the supporting frame 14; and a second frame 12b which is arranged at a right side in a criterion of the supporting frame 14 and is coupled to the first frame 12a.

Here, the first frame 12a, the second frame 12b, and the supporting frame 14 may be coupled in a hinge way, so that the first frame 12a and the second frame 12b are configured to be folded or unfolded at a certain angle in a criterion of the supporting fame 14. A hinge device may be installed inside the supporting frame 14.

As the above, the frame 10 may include the outer frame 12 including the first and second frames 12a and 12b, and the supporting frame 14. The first frame 12a and the second frame 12b are configured to be folded or unfolded at a certain angle in a criterion of the supporting fame 14. Accordingly, the frame 10 may be adjusted to be used depending on users having different sizes and shapes of the faces.

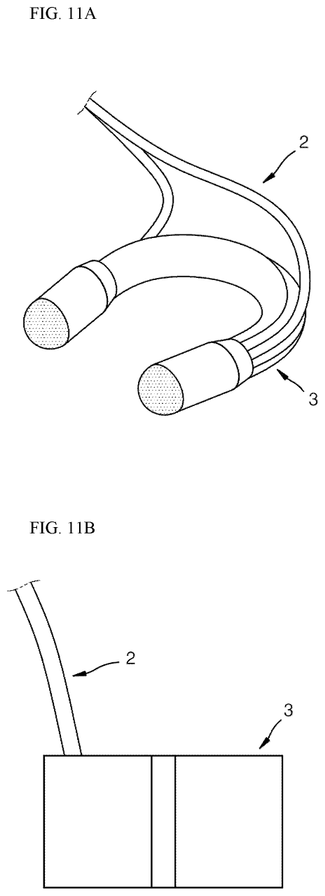

FIGS. 11A and 11B is a drawing of presenting examples of the air cleaning means of FIG. 10, wherein FIG. 11A is a neck band shape-air cleaner, and FIG. 11B is a belt wearing shape-air cleaner.

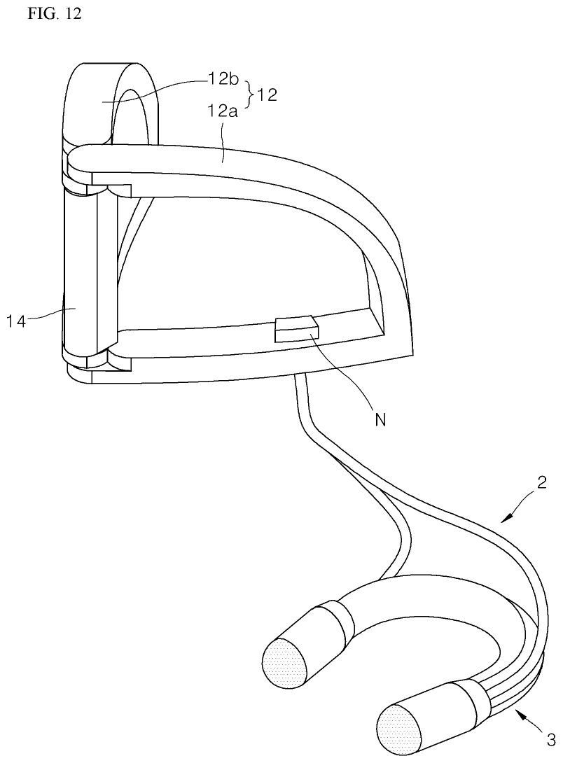

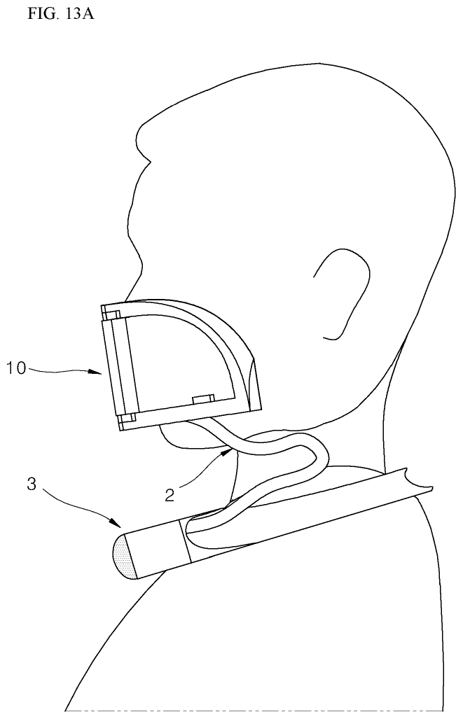

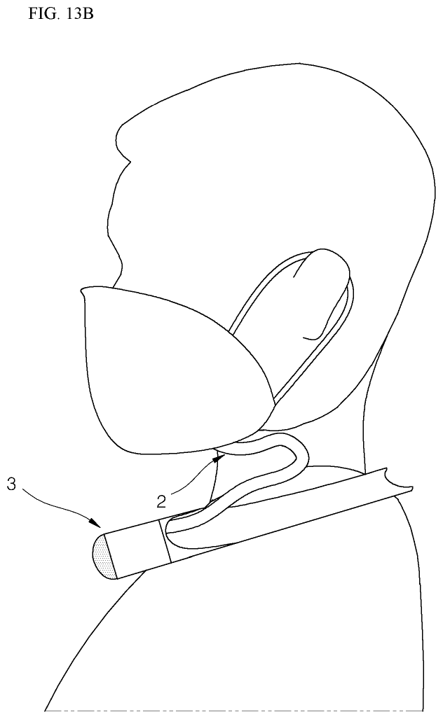

FIG. 12 is a drawing of presenting a state that the mask device for inhaling clean air and the neck band shape-air cleaner, according to the present disclosure are combined. FIG. 13A is a drawing of presenting a state that the mask device for inhaling clean air and the neck band shape-air cleaner of FIG. 12 are worn. FIG. 13B is a drawing of presenting a state of wearing a general mask on the mask device for inhaling clean air of FIG. 13A.

The air cleaning means 3 may be an air cleaner formed in a shape of a neck band to be worn around a neck of the user, or formed in a shape of being capable of wearing around a belt of the user.

As the above, the air cleaning means 3 may be prepared as the air cleaner formed in a shape of the neck band to be worn around the neck of the user, or in a shape of being capable of wearing around the belt of the user. Accordingly, there may be convenience of being portable when the user does outdoor activities.

As the above, preferable various examples of the present disclosure are described by referring to some examples. However, the description about various examples described in an item “DETAILED DESCRIPTION OF THE EMBODIMENTS” is merely exemplary. Those skilled in the art may fully understand that the present disclosure may be variously modified and implemented based on the above description, or embodiments which are equivalent to those of the present disclosure may be implemented.

Also, the following should be understood. The present disclosure may be realized in different various forms. Therefore, the present disclosure is not limited by the above description. The description as the above is for completing the content of the present disclosure, and is merely provided to fully inform those skilled in the art of a category of the present disclosure. The present disclosure is merely defined by each claim in the scope of claims.

### DESCRIPTION OF SYMBOLS

10: Frame
12: Outer frame
12a: First frame
12b: Second frame
14: Supporting frame
16: Holes for coupling
N: Nozzle portion
E: Earring portions
H: Hair band portion
F: Filter portion
2: Air tube
3: Air cleaning means
M: General mask (or a mask for blocking fine dust)

1. A wearable system for cleaning air including a mask device for wearing on a face of a user to inhale clean air, and an air cleaning means for generating clean air to be supplied to the mask device, wherein
the mask device comprises:
a frame formed in a shape of surrounding lips and a nose of the user, wherein one or more of nozzle portion for spraying clean air onto the face of the user is formed at the frame,
the nozzle portion is connected to the air cleaning means and an air tube, and
the air cleaning means is:
an air cleaner formed in a shape of a neck band to be worn around a neck of the user, or formed in a shape of being capable of wearing around a belt of the user.

2. A wearable system for cleaning air including a mask device for wearing on a face of a user to inhale clean air, and an air cleaning means for generating clean air to be supplied to the mask device, wherein
the mask device comprises:
a frame formed in a shape of surrounding lips and a nose of the user, wherein one or more of nozzle portion for spraying clean air onto the face of the user is formed at the frame,
the nozzle portion is connected to the air cleaning means and an air tube,
the frame comprises:
an outer frame for forming a boundary, and a supporting frame which is positioned at a center of the outer frame and of which an upper end and a lower end are connected to an upper side and a lower side of the outer frame respectively,
a pair of holes for coupling are formed at both sides in a criterion of the supporting frame between the outer frame and the supporting frame,
a filter portion is coupled to the holes for coupling, and
the air cleaning means is:
an air cleaner formed in a shape of a neck band to be worn around a neck of the user, or formed in a shape of being capable of wearing around a belt of the user.

3. A wearable system for cleaning air including a mask device for wearing on a face of a user to inhale clean air, and an air cleaning means for generating clean air to be supplied to the mask device, wherein
the mask device comprises:
a frame formed in a shape of surrounding lips and a nose of the user,
wherein one or more of nozzle portion for spraying clean air onto the face of the user is formed at the frame,
the nozzle portion is connected to the air cleaning means and an air tube, wherein
at both sides of the frame,
earring portions which are formed in a strap shape and are worn around ears of the user are formed, or a hair band portion which is formed in a band shape and is worn on hair of the user is formed, and wherein
the air cleaning means is:
an air cleaner formed in a shape of a neck band to be worn around a neck of the user, or formed in a shape of being capable of wearing around a belt of the user.

4. A wearable system for cleaning air including a mask device for wearing on a face of a user to inhale clean air, and an air cleaning means for generating clean air to be supplied to the mask device, wherein
the mask device comprises:
a frame formed in a shape of surrounding lips and a nose of the user, wherein one or more of nozzle portion for spraying clean air onto the face of the user is formed at the frame,
the nozzle portion is connected to the air cleaning means and an air tube,
the frame comprises:
an outer frame for forming a boundary, and a supporting frame which is positioned at a center of the outer frame and of which an upper end and a lower end are connected to an upper side and a lower side of the outer frame respectively,
a silicon layer is formed on a surface to be in contact with the face of the user in the outer frame, and
the air cleaning means is:
an air cleaner formed in a shape of a neck band to be worn around a neck of the user, or formed in a shape of being capable of wearing around a belt of the user.

5. A wearable system for cleaning air including a mask device for wearing on a face of a user to inhale clean air, and an air cleaning means for generating clean air to be supplied to the mask device, wherein
the mask device comprises:
a frame formed in a shape of surrounding lips and a nose of the user,
wherein one or more of nozzle portion for spraying clean air onto the face of the user is formed at the frame,
the nozzle portion is connected to the air cleaning means and an air tube,
the frame comprises:
an outer frame for forming a boundary, and a supporting frame which is positioned at a center of the outer frame and of which an upper end and a lower end are connected to an upper side and a lower side of the outer frame respectively,
the outer frame comprises:
a first frame which is arranged at a left side in a criterion of the supporting frame; and
a second frame which is arranged at a right side in a criterion of the supporting frame and is coupled to the first frame, wherein
the first frame, the second frame, and the supporting frame are coupled in a hinge way, so that the first frame and the second frame are configured to be folded or unfolded at a certain angle in a criterion of the supporting fame, and wherein
the air cleaning means is:
an air cleaner formed in a shape of a neck band to be worn around a neck of the user, or formed in a shape of being capable of wearing around a belt of the user.
